(19) United States
(12) Patent Application Publication
(10) Pub. No.: US 2023/0259819 A1
(43) Pub. Date: Aug. 17, 2023

(54) LEARNING DEVICE, LEARNING METHOD AND LEARNING PROGRAM

(71) Applicant: NIPPON TELEGRAPH AND TELEPHONE CORPORATION, Tokyo (JP)

(72) Inventor: Masanori YAMADA, Musashino-shi, Tokyo (JP)

(73) Assignee: NIPPON TELEGRAPH AND TELEPHONE CORPORATION, Tokyo (JP)

(21) Appl. No.: 18/014,343

(22) PCT Filed: Jul. 17, 2020
(86) PCT No.: PCT/JP2020/027875

§ 371 Date: Jan. 4, 2023

(51) Int. Cl. G06N 20/00

(52) U.S. Cl. CPC G06N 20/00

(57) ABSTRACT

A learning device includes processing circuitry configured to acquire data with a label to be predicted, and learn a model that represents probability distribution of the label of the acquired data using an eigenvector corresponding to a maximum eigenvalue in a Fisher information matrix for the data in the model.

### TECHNICAL FIELD

The present invention relates to a learning device, a learning method, and learning program.

### BACKGROUND ART

In recent years, machine learning has achieved great success. Machine learning has become a mainstream method in the fields of images and natural language, particularly with appearance of deep learning.

On the other hand, it is known that deep learning is vulnerable to attacks from adversarial examples with malicious noise loaded therein. As a powerful countermeasure against such adversarial examples, a technique called tradeoff-inspired adversarial defense via surrogate-loss minimization (TRADES) using a proxy loss has been proposed (see Non Patent Literatures 1 and 2).

### CITATION LIST

### Non Patent Literature

Non Patent Literature 1: A. Madry et al., “Towards Deep Learning Models Resistant to Adversarial Attacks”, [online], arXiv:1706.06083v4 [stat.ML], September, 2019, [accessed Jun. 25, 2020], Internet <URL: https://arxiv.org/pdf/1706.06083.pdf>
Non Patent Literature 2: H. Zhang et al., “Theoretically Principled Trade-off between Robustness and Accuracy”, [online], arXiv:1901.08573v3 [cs.LG], June, 2019, [accessed Jun. 25, 2020], Internet <URL: https://arxiv.org/pdf/1901.08573.pdf>

### SUMMARY OF INVENTION

### Technical Problem

However, it may be difficult to improve generalization performance against adversarial examples in the conventional TRADES. In other words, random numbers are used as initial values to avoid points where differentiation cannot be conventionally performed when optimal models are searched for through approximation with proxy losses, and it may thus be difficult to improve generalization performance.

The present invention was made in view of the above, and an object thereof is to learn a model that is robust to adversarial examples.

### Solution to Problem

In order to solve the aforementioned problem and to achieve the object, a learning device according to the present invention includes: an acquisition unit that acquires data with a label to be predicted; and a learning unit that learns a model that represents probability distribution of the label of the acquired data using an eigenvector corresponding to a maximum eigenvalue in a Fisher information matrix for the data in the model.

### Advantageous Effects of Invention

According to the present invention, it is possible to learn a model that is robust to adversarial examples.

### BRIEF DESCRIPTION OF DRAWINGS

FIG. 1 is a schematic diagram illustrating, as an example, a schematic configuration of a learning device.

FIG. 2 is a flowchart illustrating a learning processing procedure.

FIG. 3 is a flowchart illustrating a detection processing procedure.

FIG. 4 is a diagram for explaining an example.

FIG. 5 is a diagram for explaining an example.

FIG. 6 is a diagram illustrating, as an example, a computer that executes a learning program.

### DESCRIPTION OF EMBODIMENTS

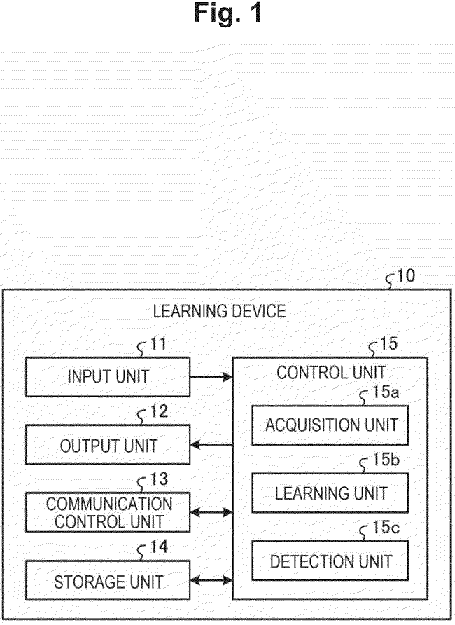

Hereinafter, an embodiment of the present invention will be described in detail with reference to the drawings. Note that the present invention is not limited by this embodiment. Further, the same portions are denoted by the same reference signs in the description of the drawings.

[Configuration of learning device] FIG. 1 is a schematic diagram illustrating, as an example, a schematic configuration of a learning device. As illustrated in FIG. 1 as an example, a learning device 10 is realized by a general-purpose computer such as a personal computer and includes an input unit 11, an output unit 12, a communication control unit 13, a storage unit 14, and a control unit 15.

The input unit 11 is realized by using an input device such as a keyboard and a mouse and inputs various kinds of instruction information such as a processing start to the control unit 15 in response to input operations of an operator. The output unit 12 is realized by a display device such as a liquid crystal display, a printing device such as a printer, or the like.

The communication control unit 13 is realized by a network interface card (NIC) or the like and controls communication between an external device such as a server and the control unit 15 via a network. For example, the communication control unit 13 controls communication between the control unit 15 and a management device or the like that manages data to be learned.

The storage unit 14 is realized by a semiconductor memory element such as a random access memory (RAM) or a flash memory or a storage device such as a hard disk or an optical disk and stores parameters and the like of a model learned through learning processing, which will be described later. Note that the storage unit 14 may be configured to communicate with the control unit 15 via the communication control unit 13.

The control unit 15 is realized by using a central processing unit (CPU) or the like and executes a processing program stored in a memory. In this manner, the control unit 15 functions as an acquisition unit 15a, a learning unit 15b, and a detection unit 15c as illustrated in FIG. 1 as an example. Note that each or some of these functional units may be implemented in different pieces of hardware. For example, the learning unit 15b and the detection unit 15c may be mounted as separate devices. Alternatively, the acquisition unit 15a may be mounted on a device that is different from the learning unit 15b and the detection unit 15c. Moreover, the control unit 15 may include other functional units.

An acquisition unit (15a) acquires data with a label to be predicted. For example, the acquisition unit 15a acquires data used for learning processing and detection processing, which will be described later, via the input unit 11 or the communication control unit 13. In addition, the acquisition unit 15a may cause the storage unit 14 to store the acquired data. Note that the acquisition unit 15a may transfer this information to the learning unit 15b or the detection unit 15c without storing it in the storage unit 14.

The learning unit 15b learns a model that represents probability distribution of the label of the acquired data using an eigenvector corresponding to a maximum eigenvalue in a Fisher information matrix for the data. Specifically, the learning unit 15b learns the model by searching for a model that minimizes a loss function using an eigenvector corresponding to the maximum eigenvalue in the Fisher information matrix for the data as an initial value of noise to be added to the data in the loss function.

Here, the model that represents the probability distribution of a label y of data x is expressed by Expression (1) below using a parameter 9. f is a vector that represents a label output by the model.

$${p}_{θ} \left({y}_{k} \left|x\right)\right) = \frac{exp {f}_{k} \left(x ; θ\right)}{{\sum }_{i} exp {f}_{i} \left(x ; θ\right)} \qquad \text{[Math. 1]}$$

The learning unit 15b learns the model by determining the parameter θ of the model such that the loss function represented by Expression (2) below becomes small. Here, p(y|x) represents true probability.

$$l \left(x , y ; θ\right) = p \left(y \left|x\right)\right) log {p}_{θ} \left(y \left|x\right)\right) \qquad \text{[Math. 2]}$$

Further, the learning unit 15b learns the model such that the label can be correctly predicted for the adversarial example represented by Expression (3) below with noise η added to the data x.

$${max}_{η} {E}_{x , y \sim p \left(x , y\right)} \left[l \left(x + η , y ; θ\right)\right] \qquad \text{[Math. 3]}$$

The learning unit 15b searches for and determines θ that minimizes the loss function represented by Expression (4) below, thereby learning a model that is robust to adversarial examples. Here, β is a constant.

$$\text{loss} = p \left(y \left|x\right)\right) log {p}_{θ} \left(y \left|x\right)\right) + β {max}_{η} \left({D}_{\text{KL}} \left({p}_{θ} \left(y \left|x\right)\right) \left‖{p}_{θ} \left(y \left|x + η\right)\right)\right)\right)\right) \qquad \text{[Math. 4]}$$

In order to minimize the loss function of Equation (4) above, the second item of Equation (4) above is differentiated and searched for as represented by Expression (5) below.

$$\begin{matrix}\frac{\partial }{\partial {x}^{′}} {D}_{\text{KL}} \left({p}_{θ} \left(y \left|x\right)\right) \left‖{p}_{θ} \left(y \left|{x}^{′}\right)\right)\right)\right) \\ \text{wherein} \\ {x}^{′} = x + {η}_{θ}\end{matrix} \qquad \text{[Math. 5]}$$

Here, if the initial value η₀ of η is set to 0 when the maximum value of the noise η is searched for while the noise η is changed in the second item of Expression (4), x ¹= x is obtained, and thus the differentiation of the second item in Expression (4) cannot be executed.

Therefore, the initial value η₀ of the noise η is set to a random number η_{rand} in the conventional TRADES. However, it may be difficult to sufficiently improve generalization performance against adversarial examples.

Here, the loss function of Expression (4) above can be transformed into Expression (6) below using the Fisher information matrix G and its eigenvalue λ.

$$\left(\begin{matrix}\begin{matrix}\text{loss} = p \left(y \left|x\right)\right) log {p}_{θ} \left(y \left|x\right)\right) + β η {G}_{i j} η \\ = p \left(y \left|x\right)\right) log {p}_{θ} \left(y \left|x\right)\right) + β λ {\left‖η\right‖}_{2}\end{matrix} \\ \text{wherein the Fisher information matrix G is} \\ {G}_{i j} ≡ {E}_{p \left(y \left|x\right)\right)} \left[\left(\frac{\partial }{\partial {{x}^{′}}_{i}} log p \left(y \left|{x}^{′}\right)\right)\right) \left(\frac{\partial }{\partial {{x}^{′}}_{j}} log p \left(y \left|{x}^{′}\right)\right)\right)\right]\end{matrix}\right\} \qquad \text{[Math. 6]}$$

The learning unit 15b according to the present embodiment learns the model using an eigenvector corresponding to a maximum eigenvalue in a Fisher information matrix G for the data x. Specifically, the learning unit 15b uses an eigenvector η_{eig} corresponding to the maximum eigenvalue of the Fisher information matrix G for the data x as the initial value η₀ of the noise η to be added to the data x as represented by Expression (7) below in Expression (5) above. Then, the model is learned by searching for θ that minimizes the loss function represented by Expression (4) above.

$${x}^{′} = x + {η}_{\text{eig}} \qquad \text{[Math. 7]}$$

In this manner, the learning unit 15b can accurately search for the parameter θ that minimizes the loss function. Therefore, the learning unit 15b can learn a model that is robust to adversarial examples.

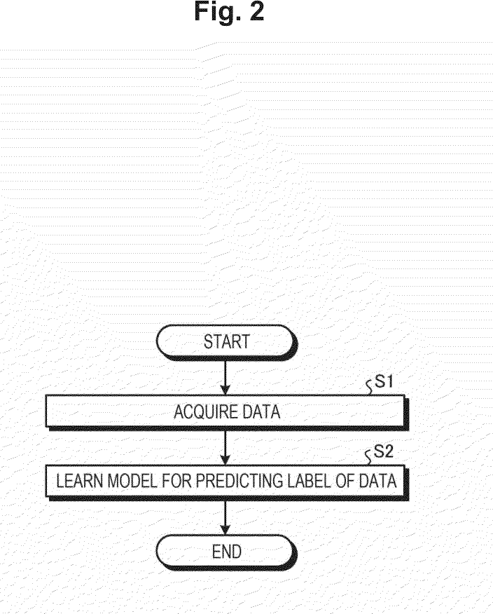

The detection unit 15c predicts a label of the acquired data using the learned model. In this case, the detection unit 15c calculates the probability of each label of newly acquired data by applying the learned parameter θ to Expression (1) above and outputs the label with the highest probability. It is thus possible to output a correct label even in a case in which the data is an adversarial example, for example. As described above, the detection unit 15c can withstand a blind spot attack and predict the correct label for the adversarial example.

[Learning processing] Next, learning processing performed by the learning device 10 according to the present embodiment will be described with reference to FIG. 2. FIG. 2 is a flowchart illustrating a learning processing procedure. The flowchart of FIG. 2 is started, for example, at a timing when there is an operation input for providing an instruction for starting the learning processing.

First, the acquisition unit 15a acquires data with a label to be predicted (Step S1).

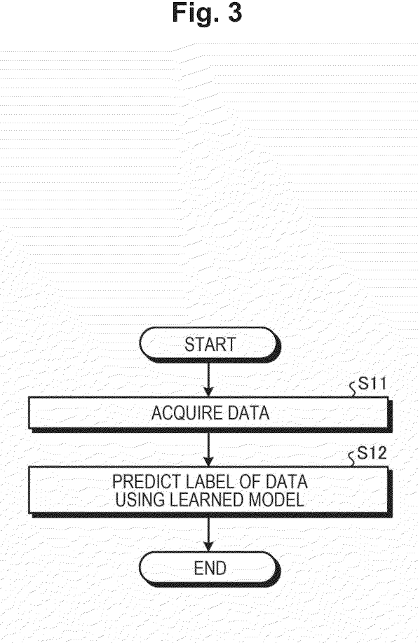

Next, the learning unit 15b learns a model that represents probability distribution of the label of the acquired data (step S1). At that time, the learning unit 15b learns the model using an eigenvector corresponding to a maximum eigenvalue in a Fisher information matrix for the data in the model. Specifically, the learning unit 15b learns the model by searching for a model that minimizes a loss function using an eigenvector corresponding to the maximum eigenvalue in the Fisher information matrix for the data as an initial value of noise to be added to the data in the loss function. In this manner, a series of learning processing ends.

[Detection processing] Next, detection processing performed by the learning device 10 according to the present embodiment will be described with reference to FIG. 3. FIG. 3 is a flowchart illustrating a detection processing procedure. The flowchart of FIG. 3 is started, for example, at a timing when there is an operation input for providing an instruction for starting the detection processing.

First, the acquisition unit 15a acquires new data with a label to be predicted similarly to the processing in Step S1. of FIG. 2 described above (Step S11).

Next, the detection unit 15c predicts the label of the acquired data using the learned model (Step S12). In this case, the detection unit 15c calculates p(x′) of newly acquired data x′ by applying the learned parameter θ to Expression (1) above and outputs the label with the highest probability. It is thus possible to output a correct label even in a case in which the data x′ is an adversarial example, for example. In this manner, a series of detection processing ends.

As described above, the acquisition unit 15a acquires data with a label to be predicted. The learning unit 15b learns a model that represents probability distribution of the label of the acquired data using an eigenvector corresponding to a maximum eigenvalue in a Fisher information matrix for the data in the model. Specifically, the learning unit 15b searches for the model that minimizes the loss function using the eigenvector corresponding to the maximum eigenvalue in the Fisher information matrix for the data as an initial value of noise to be added to the data in the loss function.

In this manner, the learning device 10 can learn the model that is robust to adversarial examples.

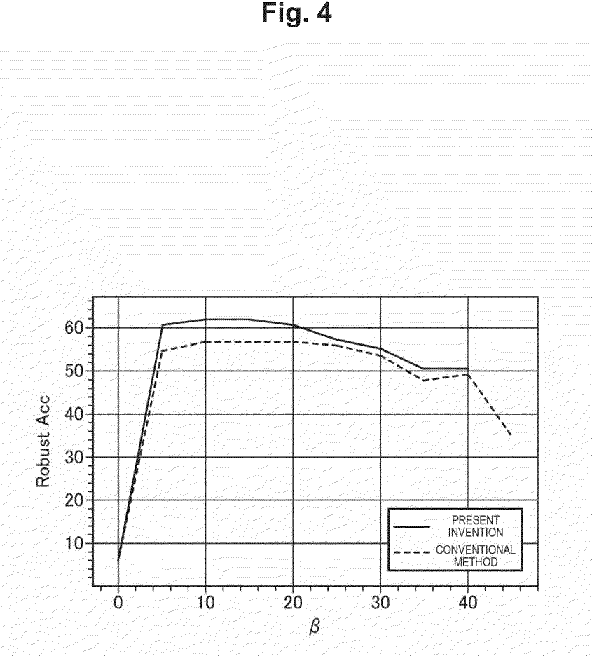

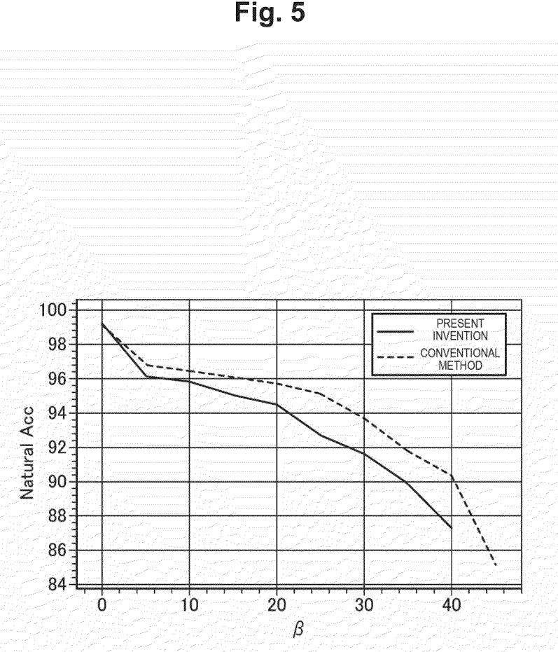

Also, the detection unit 15c predicts the label of the acquired data using the learned model. In this manner, the detection unit 15c can withstand a blind spot attack and predict the correct label for the adversarial example.

[Example] FIGS. 4 and 5 are diagrams for explaining an example of the present invention. In this example, accuracy of the model of the above embodiment was evaluated using an image data set: Cifar 10 and a deep learning model: Resnet 18. Specifically, the model in the above embodiment and the model in the conventional method learned by changing β in the loss function represented by Expression (4) above were evaluated using test data and an adversarial example generated from the test data by a method called PGD.

As parameters of PGD, esp = 8/255, train iter = 7, eval_iter = 20, eps_iter = 0.01, rand_init = True, clip_min = 0.0, and clip_max = 1.0 were used.

Then, an accuracy rate (hereinafter, referred to as natural acc) of top1 for the test data and an accuracy rate (hereinafter, referred to as robust acc) of top1 for the adversarial example generated from the test data were calculated.

FIG. 4 illustrates, as an example, a relationship between robust acc and β. Also, FIG. 5 illustrates, as an example, a relationship between natural acc and β. As illustrated in FIG. 4, it is possible to ascertain that prediction precision for the adversarial example did not depend on β in both the model in the present invention (embodiment) and the model in the conventional method. On the other hand, as illustrated in FIG. 5, prediction accuracy for ordinary data was further degraded in both the model in the present invention and the model in the conventional method as β increased. This is because the second item in Expression (4) above has a greater influence as β increases because the first item is a part representing a loss function for the ordinary data, and the second item is a part representing a loss function for the adversarial example.

Therefore, β in a case where robust acc was high was employed to compare accuracy of each model. As a result, β = 20, Robust Acc = 56.87, and Natural Acc = 95.75 in the model in the conventional method. Also, β = 10, Robust Acc = 61.62, and Natural Acc = 95.84 in the model in the present invention. In this manner, it is possible to ascertain that the values of the model of the present invention were higher than those of the model in the conventional method regardless of β. In this manner, it was confirmed that the model in the embodiment was able to learn the model that was robust to adversarial examples in accordance with the second item in Expression (4) above.

[Program] It is also possible to produce a program that describes, in a computer executable language, the processing executed by the learning device 10 according to the above embodiment. In an embodiment, the learning device 10 can be implemented by installing a learning program for executing the above learning processing as packaged software or online software in a desired computer. For example, an information processing apparatus can be caused to function as the learning device 10 by causing the information processing apparatus to execute the above learning program. In addition to the above, the information processing apparatus includes, within its range, mobile communication terminals such as a smartphone, a mobile phone, and a personal handyphone system (PHS), and further includes slate terminals such as a personal digital assistant (PDA). Further, the functions of the learning device 10 may be implemented in a cloud server.

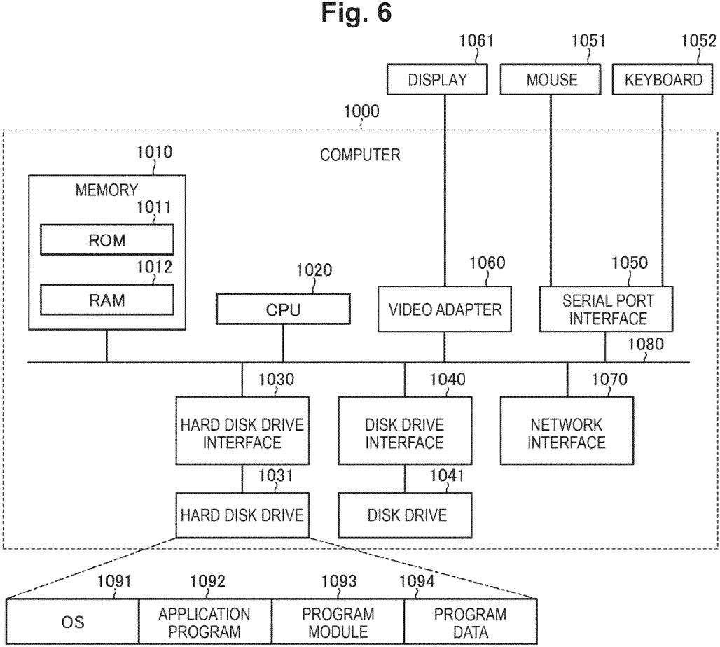

FIG. 6 is a diagram illustrating an example of a computer that executes the learning program. A computer 1000 includes, for example, a memory 1010, a CPU 1020, a hard disk drive interface 1030, a disk drive interface 1040, a serial port interface 1050, a video adapter 1060, and a network interface 1070. These components are connected by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disc is inserted into the disk drive 1041. A mouse 1051 and a keyboard 1052, for example, are connected to the serial port interface 1050. A display 1061, for example, is connected to the video adapter 1060.

Here, the hard disk drive 1031 stores, for example, an OS 1091, an application program 1092, a program module 1093, and program data 1094. All of the information described in the above embodiment is stored in the hard disk drive 1031 or the memory 1010, for example.

In addition, the learning program is stored in the hard disk drive 1031 as a program module 1093 in which commands to be executed by the computer 1000, for example, are described. Specifically, the program module 1093 in which all of the processing executed by the learning device 10 described in the above embodiment is described is stored in the hard disk drive 1031.

Further, data used for information processing performed by the learning program is stored as program data 1094 in the hard disk drive 1031, for example. Then, the CPU 1020 reads, in the RAM 1012, the program module 1093 and the program data 1094 stored in the hard disk drive 1031 as needed and executes each procedure described above.

Note that the program module 1093 and the program data 1094 related to the learning program are not limited to being stored in the hard disk drive 1031, and may be stored in, for example, a removable storage medium and read by the CPU 1020 via a disk drive 1041 or the like. Alternatively, the program module 1093 and the program data 1094 related to the learning program may be stored in another computer connected via a network such as a local area network (LAN) or a wide area network (WAN) and may be read by the CPU 1020 via the network interface 1070.

Although the embodiments to which the invention made by the present inventor is applied have been described above, the present invention is not limited by the description and drawings constituting a part of the disclosure of the present invention according to the present embodiments. In other words, other embodiments, examples, operation techniques, and the like made by those skilled in the art and the like on the basis of the present embodiments are all included in the scope of the present invention.

Reference Signs List

| | |
|---|---|
| 10 | Learning device |
| 11 | Input unit |
| 12 | Output unit |
| 13 | Communication control unit |
| 14 | Storage unit |
| 15 | Control unit |
| 15 a | Acquisition unit |
| 15 b | Learning unit |
| 15 c | Detection unit |

1. A learning device comprising:
processing circuitry configured to:
acquire data with a label to be predicted; and
learn a model that represents probability distribution of the label of the acquired data using an eigenvector corresponding to a maximum eigenvalue in a Fisher information matrix for the data in the model.

2. The learning device according to claim 1, wherein the processing circuitry is further configured to use the eigenvector as an initial value of noise to be added to the data in a loss function.

3. The learning device according to claim 1, wherein the processing circuitry is further configured to predict the label of the acquired data using the learned model.

4. A learning method executed by a learning device comprising:
acquiring data with a label to be predicted; and
learning a model that represents probability distribution of the label of the acquired data using an eigenvector corresponding to a maximum eigenvalue in a Fisher information matrix for the data in the model.

5. A non-transitory computer-readable recording medium storing therein a learning program that causes a computer to execute a process comprising:
acquiring data with a label to be predicted; and
learning a model that represents probability distribution of the label of the acquired data using an eigenvector corresponding to a maximum eigenvalue in a Fisher information matrix for the data in the model.
